(19) United States
(12) Patent Application Publication
(10) Pub. No.: US 2001/0048404 A1
(43) Pub. Date: Dec. 6, 2001

(54) Ceiling mounted monitor system

(75) Inventors: Mark A. Cook, Springfield, OR (US); Terrence S. Melvin, Eugene, OR (US); Charles A. Paul JR., Veneta, OR (US)

Correspondence Address: Kolisch, Hartwell, Dickinson, McCormack & Heuser, 200 Pacific Building, 520 S.W. Yamhill Street, Portland, OR, 97204, US

(73) Assignee: Rosen Products LLC.

(21) Appl. No.: 09/851,695

(22) Filed: May 8, 2001

Related U.S. Application Data
(60) Provisional application No. 60/206,590, filed on May 23, 2000.

(51) Int. Cl. G09G 5/00

(52) U.S. Cl. 345/7

(57) ABSTRACT

A ceiling-mounted monitor system is provide, the monitor system including a housing mounted on a ceiling of a vehicle, a video display monitor mounted on the housing, and a video source mounted in side-by-side relation with the video display monitor.

### CROSS-REFERENCE TO RELATED APPLICATION

This application claims priority from U.S. Provisional Patent Application Serial No. 60/206,590, filed May 23, 2000 for a CEILING-MOUNTED VIDEO DISPLAY SYSTEM WITH SIDE-BY-SIDE MONITOR AND VIDEO SOURCE.

### TECHNICAL FIELD

The present invention relates generally to vehicle ceiling-mounted video display systems, and more particularly to a ceiling-mounted video display system having a video source and video display monitor in a side-by-side relationship.

### BACKGROUND

In recent years entertainment and information video display systems have found applications in vehicles. Reception of television broadcast signals, however, is inconsistent in a moving vehicle due to changing geography. As a result, it may be convenient to include in a vehicle a video source capable of providing in-vehicle entertainment and information. Examples of ceiling-mounted video display systems incorporating a video source are shown in U.S. Pat. Nos. 5,775,762 and 5,927,784, both to Vitito.

Unfortunately, the entertainment systems disclosed by Vitito include a video source located some distance rearward of the video display monitor. This configuration presents drawbacks, particularly when an occupant near the front of the vehicle would like to have access to the video source. To address this problem, it would be desirable to incorporate a video source in a relation to the video display monitor, which permits an occupant near the front of the vehicle to access the video source.

### SUMMARY

The foregoing concerns are addressed by provision of a ceiling-mounted information and entertainment display system which includes a housing mounted on the ceiling of a vehicle, a display monitor mounted to the housing, and a video source mounted in side-by-side relation to the video display monitor.

### BRIEF DESCRIPTION OF THE DRAWINGS

FIG. 1 is an isometric view of an entertainment and information video display unit constructed in accordance with one embodiment of the present invention, the display monitor being shown in a deployed position;

FIG. 2 is an isometric view of the entertainment and information display system of FIG. 1, mounted on the ceiling of a vehicle;

FIG. 3 is a side view of the entertainment and information display system of FIG. 1, showing a video monitor recess in phantom lines;

FIG. 4 is a somewhat schematic bottom plan view of the entertainment and information display system of FIG. 1, showing a schematic wiring harness in phantom lines.

### DETAILED DESCRIPTION OF THE INVENTION

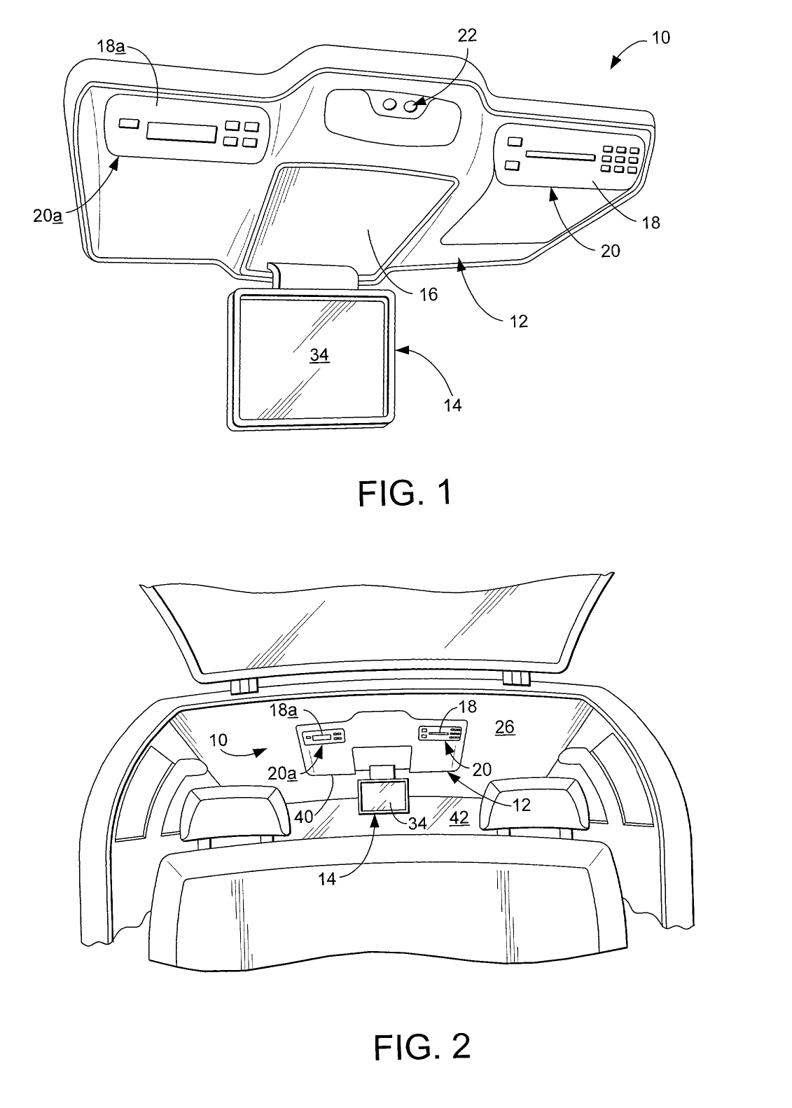

An entertainment system according to the present invention is shown generally at 10 in FIG. 1, the system including a housing 12, configured to mount centrally to a ceiling of an automobile. The housing carries a video display monitor 14 configured for storage in a video display monitor recess 16, and a video source 18, which typically is removably installed in a video source cavity 20. As indicated, video display monitor 14 is mounted beside video source cavity 20 in side-by side relation thereto.

Additionally, system housing 12 may include a second video source cavity 20a, for receipt of a second video source 18a. Second video source cavity 20a is positioned beside the video display monitor 14, opposite video source cavity 20.

Turning to FIG. 2, it will be appreciated that system housing 12 is mounted to a ceiling 26 of a vehicle 24. System housing 12 is mounted centrally on vehicle ceiling 26, and may be coextensive with the ceiling. It should be understood however, that the system may be mounted anywhere on the vehicle ceiling. In the depicted embodiment, the mounting location of the system is optimized for viewing based on the layout of the interior of the vehicle. System housing 12 is sized to permit video display monitor 14, and a video source 18, to be at least partially enclosed as will be described further below. Typically, video source 18 is completely enclosed within system housing 12.

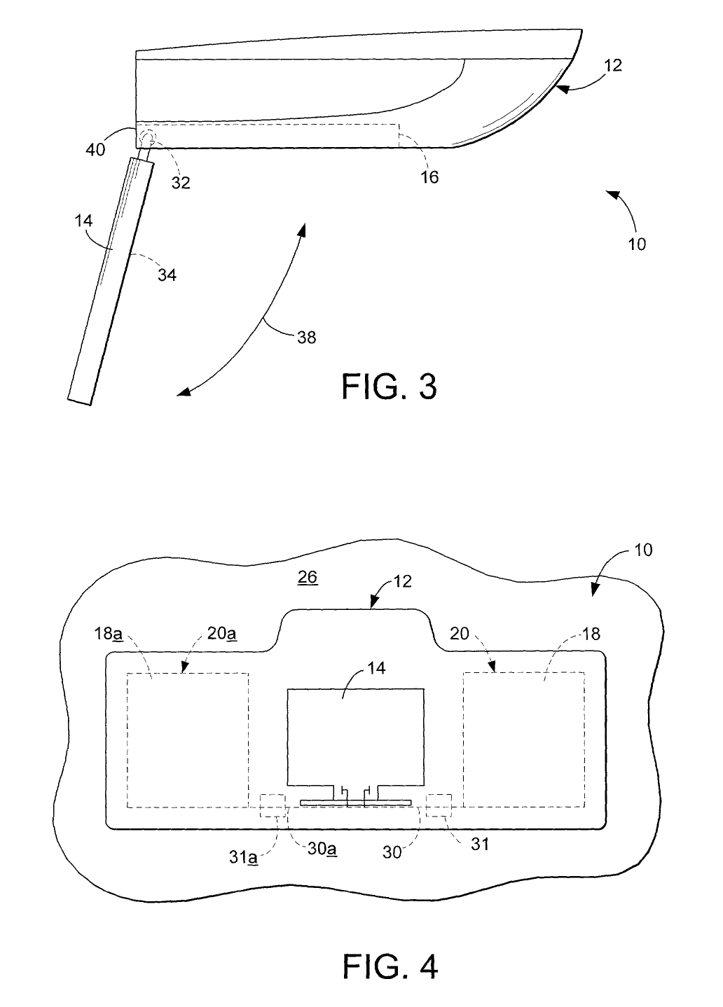

Video display monitor 14 is operatively mounted adjacent a front edge 40 of system housing 12, the monitor being pivotal about a display monitor pivot 32 (FIG. 3). Mounting video display monitor 14 to front edge 40, which is located near the front windshield of the vehicle, optimizes viewability of the entertainment system and provides front seat passengers access to the system housing.

System housing 12 includes a video display monitor recess 16 located centrally on the system housing, aft of the monitor pivot 32. The video display monitor recess 16 is configured to at least partially enclose the video display monitor 14. Monitor recess 16 typically is sized to correspond to the size and shape of video display monitor 14.

As shown in FIGS. 1-3, the video display monitor may be pivoted to a deployed position in which the monitor extends downwardly from system housing 12. In the deployed position the monitor presents a viewing screen 34 to passengers within the vehicle, as best shown in FIG. 2.

Video display monitor 14 also may be pivoted to a stowed position, where the monitor is generally coplanar with the ceiling of the vehicle and at least partially enclosed within the system housing 12. FIG. 4 shows the video display monitor 14 in the stowed position. In the stowed position, video display monitor recess 16 allows video display monitor 14 to lie generally flush with system housing 12. A latch (not shown) may be used to secure video display monitor 14 in place within recess 16.

Video display monitor 14 moves from the stowed position to the deployed position by pivoting about pivot 32, which includes a friction hinge having an axis extending along a top edge 36 of monitor 14. The rotation between the stowed position and the deployed position is indicated in FIG. 3, by directional arrow 38. Video display monitor 14 typically may be selectively positioned anywhere between its stowed position and its deployed position, held there by the frictional resistance of the friction hinge of pivot 32. The optimal viewing angle may be an acute angle somewhere between perpendicular to the ceiling of the vehicle and parallel to the ceiling.

As indicated above, the entertainment system 10 may include more than one video source, the depicted entertainment system including video sources 18 and 18a. Correspondingly, entertainment system housing 12 may include more than one video source recess, the depicted housing defining video source recesses 20 and 20a, each being configured for receipt of a video source. Each video source recess is capable of housing a video source adapted to transmit a video signal to the video display monitor 14. The video source recesses typically are positioned on opposite sides of video display monitor 14. In the present embodiment, the entertainment system housing 12 includes a source selector 22 that enables the viewer to determine which video source, 18 or 18a, will be displayed.

The video sources may be any of a number of possible types of devices, including a digital video disc (DVD) player, a video cassette player (VCP), or other similar device. Additionally, the video source may be adapted to cooperate with other components of the vehicle's electronics system, including a vehicle stereo, for example.

Entertainment system 10 may be configured for easy removal of the video source 18, 18a. The removability of the video source may be accomplished by incorporating a quick-disconnect mechanism 31, 31a to each video and power wiring harness 30, 30a, as shown in FIG. 4. A video source thus may be removed from video source cavity by disconnecting the associated quick-disconnect mechanism and sliding the video source out of the cavity. Incorporating removable video sources permits the exchange of one type of video source for another. For example, a DVD player may be removed and a video cassette player may be installed in its place. This feature also enables the video source to be used in other settings such as in the home or in another vehicle.

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this, or a later application. Where the claims recite “a” or “a first” element or the equivalent thereof, such claims should be understood to include incorporation of one or more such elements, neither requiring nor excluding two or more such elements.

We claim:

1. In a vehicle, a ceiling-mounted display system comprising:
a housing mounted on a ceiling of a vehicle;
a video display monitor operatively mounted on the housing; and
a video source operatively mounted on the housing in side-by-side relation to the video display monitor.

2. The display system of claim 1, wherein the housing includes a first cavity on a first side of the video display monitor, the first cavity being configured for the removable receipt of a video source

3. The display system of claim 2, wherein the housing further includes a second cavity on a second side of the video display monitor, the second cavity being configured for removable receipt of a second video source.

4. The display system of claim 1, wherein the video display monitor is pivotal between a stowed position wherein the video display monitor is generally coplanar to the ceiling of the vehicle and a deployed position wherein the video display monitor projects downwardly from the ceiling of the vehicle.

5. The display system of claim 1, wherein the video source is a digital video disc player.

6. The display system of claim 1, wherein the video source is a video cassette player.

7. A vehicle comprising:
a ceiling;
a video display monitor operatively mounted to the ceiling; and
a video source operatively mounted to the ceiling in a side-by-side relation to the video display monitor and positioned for access by a front seat passenger.

8. The vehicle of claim 7, wherein the vehicle includes a housing which defines a first cavity on a first side of the video display monitor, the first cavity being configured for the receipt of a first video source.

9. The vehicle of claim 8, wherein the housing further defines a second cavity on a second side of the video display monitor, opposite the first side of the video display monitor, the second cavity being configured for receipt of a second video source.

10. The vehicle of claim 9, wherein the video display monitor is configured for pivot between a stowed position wherein the video display monitor is generally co-planar to the ceiling of a vehicle and a deployed position wherein the video display extends away from the ceiling of the vehicle.

11. The vehicle of claim 10, wherein the video display monitor may be selectively positioned anywhere between the stowed position and the deployed position.

12. The vehicle of claim 9, wherein the video source is a digital video disc player.

13. The vehicle of claim 9, wherein the video source is a video cassette player.

14. In a vehicle, a ceiling-mounted display system comprising:
a housing mounted on a ceiling of a vehicle, the housing having a cavity configured for removable receipt of a video source;
a video display monitor mounted on the housing and configured to pivot selectively between a stowed position wherein the video display monitor is generally coplanar to the ceiling of the vehicle and a deployed position wherein the video display monitor extends away from the ceiling of the vehicle; and
a video source mounted on the housing in side-by-side relation with the video display monitor.
